(19) United States
(12) Patent Application Publication
(10) Pub. No.: US 2004/0172236 A1
(43) Pub. Date: Sep. 2, 2004

(54) Multi-language communication system

(76) Inventor: Grant E. Fraser, Santa Rosa, CA (US)

Correspondence Address: Michael S. Neustel, Suite No.4, 2534 South University Drive, Fargo, ND, 58103, US

(21) Appl. No.: 10/377,243

(22) Filed: Feb. 27, 2003

(51) Int. Cl. G06F 17/28

(52) U.S. Cl. 704/4

(57) ABSTRACT

A multi-language communication system for facilitating effective communications between a person of a first language and a person of a second language. The multi-language communication system includes a database containing statements and questions with corresponding phonetic equivalents and/or audible voice file, and an interface for displaying a series of statements and questions along with the corresponding phonetic equivalent from the database. The user selects the language to be translated and then is guided through a series of statements and questions based upon user input. The user states the phonetic equivalent or plays the audible voice file of the statement or question as displayed and then enters a selection based upon the second person's response.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to language translation systems and more specifically it relates to a multi-language communication system for facilitating effective communications between a person of a first language and a person of a second language.

2. Description of the Related Art

Language translation systems have been in use for years for assisting in communicating with individuals of another language. There are numerous books available that assist individuals in translating and speaking a different language utilizing a variety of methods including phonetic translations. Another language translation system involves utilizing a third-party interpreter who is fluent in both languages who can be expensive and difficult to locate in a timely manner.

Unfortunately, conventional language translation systems do not provide an effective system for facilitating communications between a first person and a second person of different languages. Conventional language translation systems require the user to “look up” various terms and definitions which can be time consuming and confusing. Another problem with conventional language translation systems is that they require the individual to first know what question or answer they desire to state and then find the corresponding translation thereof. A further problem with conventional language translation systems is that they often times result in misunderstandings between individuals attempting to communicate with one another.

While these language translation systems may be suitable for the particular purpose to which they address, they are not as suitable for facilitating effective communications between a person of a first language and a person of a second language. Conventional translation devices and systems are not effective for allowing an individual to effectively communicate with others of different languages.

In these respects, the multi-language communication system according to the present invention substantially departs from the conventional concepts and designs of the prior art, and in so doing provides a system primarily developed for the purpose of facilitating effective communications between a person of a first language and a person of a second language.

### BRIEF SUMMARY OF THE INVENTION

In view of the foregoing disadvantages inherent in the known types of communication assisting devices now present in the prior art, the present invention provides a new multi-language communication system wherein the same can be utilized for facilitating effective communications between a person of a first language and a person of a second language.

The general purpose of the present invention, which will be described subsequently in greater detail, is to provide a new multi-language communication system that has many of the advantages of the language translation systems mentioned heretofore and many novel features that result in a new multi-language communication system which is not anticipated, rendered obvious, suggested, or even implied by any of the prior art language translation devices, either alone or in any combination thereof.

To attain this, the present invention generally comprises a database containing statements, questions and corresponding answers with corresponding phonetic equivalents and/or audible voice files, and an interface for displaying a series of statements and questions along with the corresponding phonetic equivalent from the database. The user selects the language to be translated and then is guided through a series of statements and questions based upon user input. The user states the phonetic equivalent and/or plays the associated audible voice file of the statement or question as displayed and then enters a selection based upon the second person's response.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a multi-language communication system that will overcome the shortcomings of the prior art systems.

A second object is to provide a multi-language communication system for facilitating effective communications between a person of a first language and a person of a second language.

Another object is to provide a multi-language communication system that may be utilized in various situations, tasks and industries such as but not limited medical, law enforcement, banking, home, travel, shopping and the like.

An additional object is to provide a multi-language communication system that may be implemented upon non-portable and portable computer devices.

A further object is to provide a multi-language communication system that reduces the amount of time required to communicate with an individual of a different language.

Another object is to provide a multi-language communication system that provides a series of questions with a phonetic equivalent and spoken equivalent via digitized voice files recorded from a native speaker of the second language to be presented to an individual of a different language.

A further object is to provide a multi-language communication system that provides varying questions based upon answers to previous related questions.

Another object is to provide a multi-language communication system that may assist in communicating with individuals of various languages including but not limited to English, German, Spanish, French and the like.

A further object is to provide a multi-language communication system that provides prompt and efficient communications with a person of a different language.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram of an exemplary computer system which may be utilized to implement the present invention.

FIG. 2 is a flowchart illustrating the overall functionality of the present invention.

FIG. 3 is a flowchart illustrating the operation of the display interface and the playing of the associated audio file.

FIG. 4 is an exemplary interface illustrating a main menu.

FIG. 5 is the exemplary interface illustrating an introduction to a Spanish speaking medical patient.

FIG. 6a is the exemplary interface illustrating a listing of command categories.

FIG. 6b is the exemplary interface illustrating a listing of medical categories.

FIG. 6c is the exemplary interface illustrating a listing of illness categories.

FIG. 6d is the exemplary interface illustrating a listing of specific items for a category/sub-category illness.

FIG. 6e is the exemplary interface illustrating a question relating to the selected specific item.

FIG. 6f is the exemplary interface illustrating a listing of more detailed questions relating to the specific item.

FIG. 6g is the exemplary interface illustrating a listing of questions relating to the medical condition.

FIG. 6h is the exemplary interface illustrating the selection of an answer to the question.

### DETAILED DESCRIPTION OF THE INVENTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), SD (Secure Digital) Cards, and computer instruction signals embodied in a transmission medium (with or without a carrier wave upon which the signals are modulated). For example, the transmission medium may include a communications network, such as the Internet.

A. Exemplary Computer System

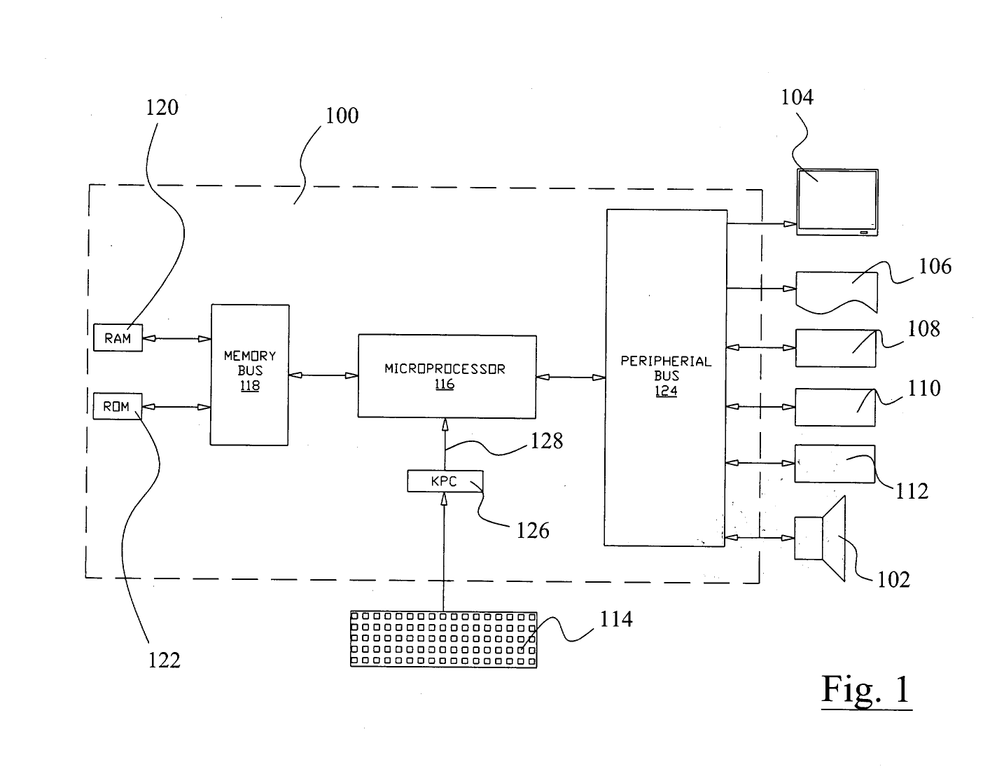

FIG. 1 is a block diagram of an exemplary computer system 100 for practicing the various aspects of the present invention. The computer system 100 includes a display screen (or monitor) 104, a printer 106, a floppy disk drive 108, a hard disk drive 110, a network interface 112, and a keyboard 114. The computer system 100 also includes a microprocessor 116, a memory bus 118, random access memory (RAM) 120, read only memory (ROM) 122, a peripheral bus 124, and a keyboard controller 126. Computer system 100 can be a personal computer (such as an APPLE computer, an IBM computer, or one of the compatibles thereof), a workstation computer (such as a SUN MICROSYSTEMS or HEWLETT-PACKARD workstation), or various other types of computers. It can be appreciated that the computer system 100 may be comprised of various other electronic devices including but not limited to mobile phones, telephones, personal digital assistants (PDAs), handheld wireless devices, two-way radios, communicators, video viewing units, television units, television receivers, cable television receivers, pagers, communication devices, and digital satellite receiver units.

The microprocessor 116 is a general-purpose digital processor that controls the operation of the computer system 100. Microprocessor 116 can be a single-chip processor or implemented with multiple components. Using instructions retrieved from memory, microprocessor 116 controls the reception and manipulations of input data and the output and display of data on output devices.

The memory bus 118 is utilized by the microprocessor 116 to access the RAM 120 and the ROM 122. RAM 120 is used by microprocessor 116 as a general storage area and as scratch-pad memory, and can also be used to store input data and processed data. ROM 122 can be used to store instructions or program code followed by microprocessor 116 as well as other data.

Peripheral bus 124 is used to access the input, output and storage devices used by the computer system 100. In the described embodiment(s), these devices include a display screen 104, a printer device 106, a floppy disk drive 108, a hard disk drive 110, and a network interface 112. A keyboard controller 126 is used to receive input from the keyboard 114 and send decoded symbols for each pressed key to microprocessor 116 over bus 128.

The display screen 104 is an output device that displays images of data provided by the microprocessor 116 via the peripheral bus 124 or provided by other components in the computer system 100. The printer device 106 when operating as a printer provides an image on a sheet of paper or a similar surface. Other output devices such as a plotter, typesetter, etc. can be utilized in place of, or in addition to, the printer device 106.

The floppy disk drive 108 and the hard disk drive 110 can be utilized to store various types of data. The floppy disk drive 108 facilitates transporting such data to other computer systems, and the hard disk drive 110 permits fast access to large amounts of stored data.

The microprocessor 116 together with an operating system operate to execute computer code and produce and use data. The computer code and data may reside on RAM 120, ROM 122, or hard disk drive 110. The computer code and data can also reside on a removable program medium and loaded or installed onto computer system 100 when needed. Removable program mediums include, for example, CD-ROM, PCCARD, floppy disk and magnetic tape.

The network interface circuit 112 is utilized to send and receive data over a network connected to other computer systems. An interface card or similar device and appropriate software implemented by microprocessor 116 can be utilized to connect the computer system 100 to an existing network and transfer data according to standard protocols.

The keyboard 114 is used by a user to input commands and other instructions to the computer system 100. Other types of user input devices can also be used in conjunction with the present invention. For example, pointing devices such as a computer mouse, a track ball, a stylus, or a tablet to manipulate a pointer on a screen of the computer system 100.

The present invention can also be embodied as computer readable code on a computer readable medium. The computer readable medium is any data storage device that can store data which can be thereafter be read by a computer system. Examples of the computer readable medium include read-only memory, random-access memory, secure digital cards, memory sticks, memory cards, magnetic data storage devices such as diskettes, and optical data storage devices such as CD-ROMs. The computer readable medium can also be distributed over a network coupled computer systems so that the computer readable code is stored and executed in a distributed fashion.

The present invention may be embodied within various languages and technologies such as but not limited to JAVA, JAVASCRIPT, JSCRIPT, WMLSCRIPT, ACTIVEX, CGI, scripts, plug-ins, BASIC, VISUAL BASIC, C, C++, COBOL, FORTRAN, ADA, HTML, DHTML, XML, SGML, WML, HDML, FLASH, SHOCKWAVE, GIF, JPEG, ADOBE ACROBAT, PDF, MICROSOFT WORD, and PASCAL. The present invention may be operated upon various operating systems such as but not limited to UNIX, MACINTOSH, LINUX, WINDOWS, PALMOS, EPOC, WINDOWS CE, FLEXOS, OS/9, and JAVAOS.

The present invention may also be utilized upon global computer networks, local area networks (LAN), wide area networks (WAN), campus area networks (CAN), metropolitan-area networks (MAN), and home area networks (HAN). Various protocols may be utilized by the electronic devices for communications such as but not limited to HTTP, SMTP, FTP and WAP (Wireless Application Protocol). The present invention may be implemented upon various wireless networks such as but not limited to CDPD, CDMA, GSM, PDC, PHS, TDMA, FLEX, REFLEX, IDEN, TETRA, DECT, DATATAC, and MOBITEX. The present invention may also be utilized with online services and internet service providers such as AMERICA ONLINE (AOL), COMPUSERVE, WEBTV, and MSN INTERNET SERVICES.

B. Interface

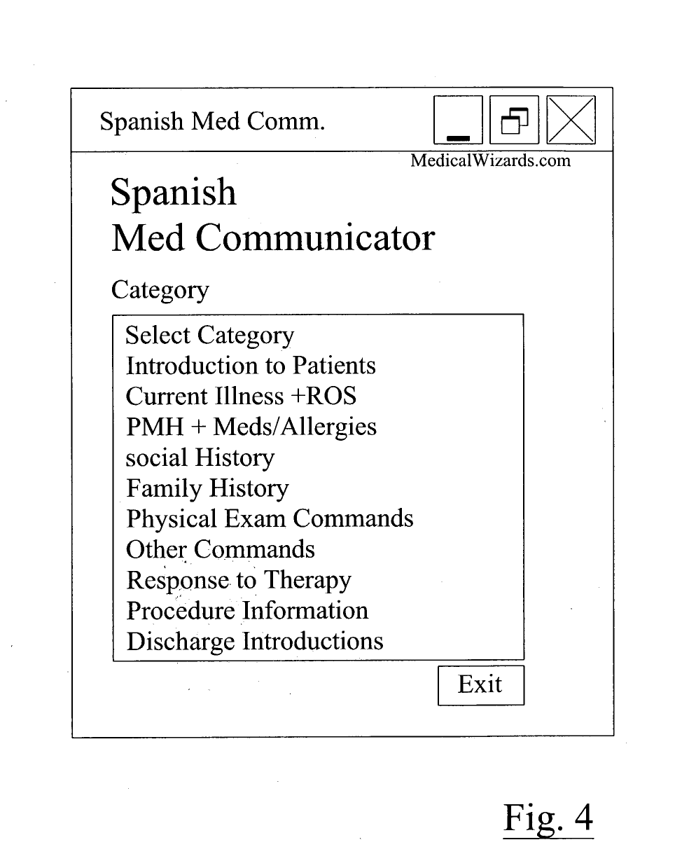

The interface utilized within the present invention may be comprised of various commonly utilized interfaces. FIGS. 4 through 8 illustrate an exemplary interface which allows for the user to either exit, make selections, select answers, select questions, data entry, print and various other commonly utilized functionality. It should be noted that FIGS. 4 through 8 illustrate a medical communicator version of the present invention for illustration purposes only. As stated previously, the present invention may be utilized in various other professions and industries for communicating with an individual of a different language and the figures should not limit the scope or purpose of the present invention.

C. Phonetic Equivalents

Phonetic equivalents of words in a first language allow easy translation to words in a second language and have been in use for years in the form of phonetic dictionaries. The present invention utilizes the phonetic equivalents of words in one language for translating into a second language understandable to a second person. This facilitates efficient communication between the first person and the second person without requiring the first person to page through numerous pages of a phonetic dictionary. The first language and the second language may be comprised of any known language including but not limited to English, Spanish, French and German.

For example, the English question “Have you had pain in the left arm?” has a Spanish phonetic equivalent of “ah sehn-tee-doh doh-lohr ehn ehl brah-soh ees-keeher-do”. The English question “Have you had headaches?” has a Spanish phonetic equivalent of “Ah the-nee-doh doh-lohr deh kah-beh-sah.” The English question “Do you drink alcohol?” has a Spanish phonetic equivalent of “Toh-mah beh-bee-dahs ahlkoh-lee-kahs.” Various other phonetic equivalents are possible in various other languages depending upon the questions and statements desired to be made to a person of a second language.

D. Digital Voice Files

In conjunction with or separate from the display of the phonetic equivalent, digital voice files spoken by a native speaker of the second language may be maintained associated with each of the statements, questions or answers. The digital voice files may be played either automatically or upon command of the user. The digital voice files may be played while the phonetic equivalent is displayed so the individual utilizing the present invention may audibly follow the audible statements being made from the present invention.

E. Main Menu

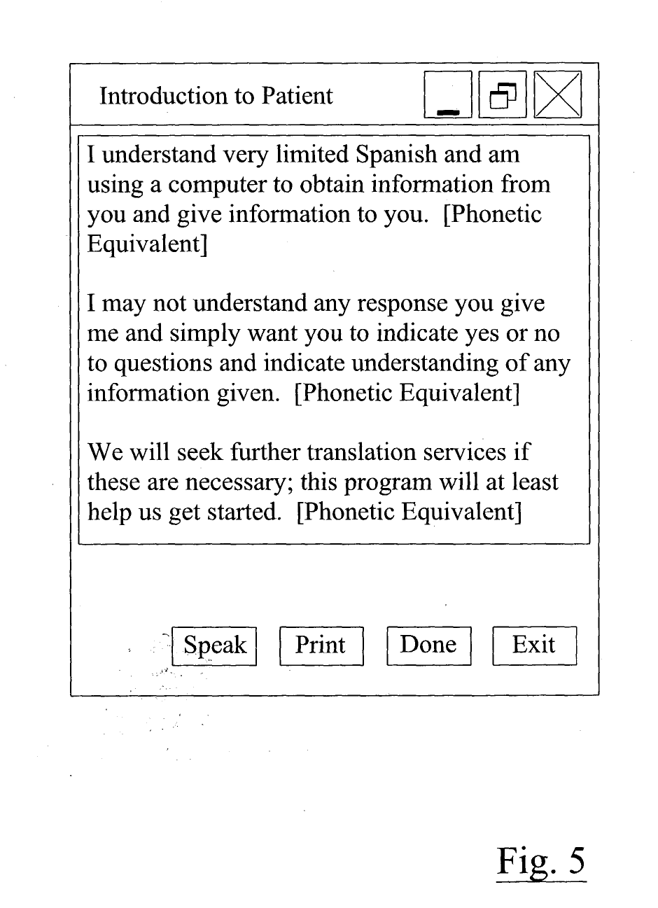

FIG. 4 illustrates an exemplary main menu illustrating example main selections. The user would first make a selection that is appropriate for the situation they are involved with. For example, if a physician needs to communicate with a patient, the physician may select “Introduction to Patient” which displays text in the language of the physician and the phonetic equivalent relating to the language of the patient as illustrated in FIG. 5 of the drawings.

The physician is able to silently read the introduction statement illustrated in their language (FIG. 5 illustrates their language as English) or select a button that allows for the audible playing of the associated digital voice file. The physician then audibly reads the phonetic equivalent of the introduction statement which follows the introduction statement. The phonetic equivalent may be displayed after each word, every other word, each sentence, or each paragraph. It is preferable that the phonetic equivalent be displayed after each sentence as illustrated in FIG. 5.

F. Sub-Menus

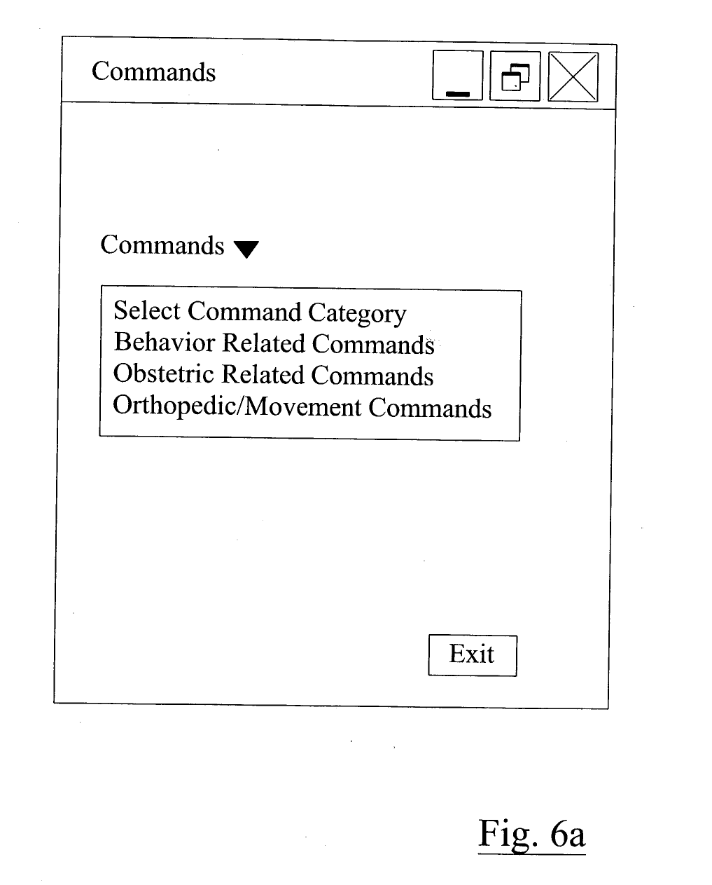

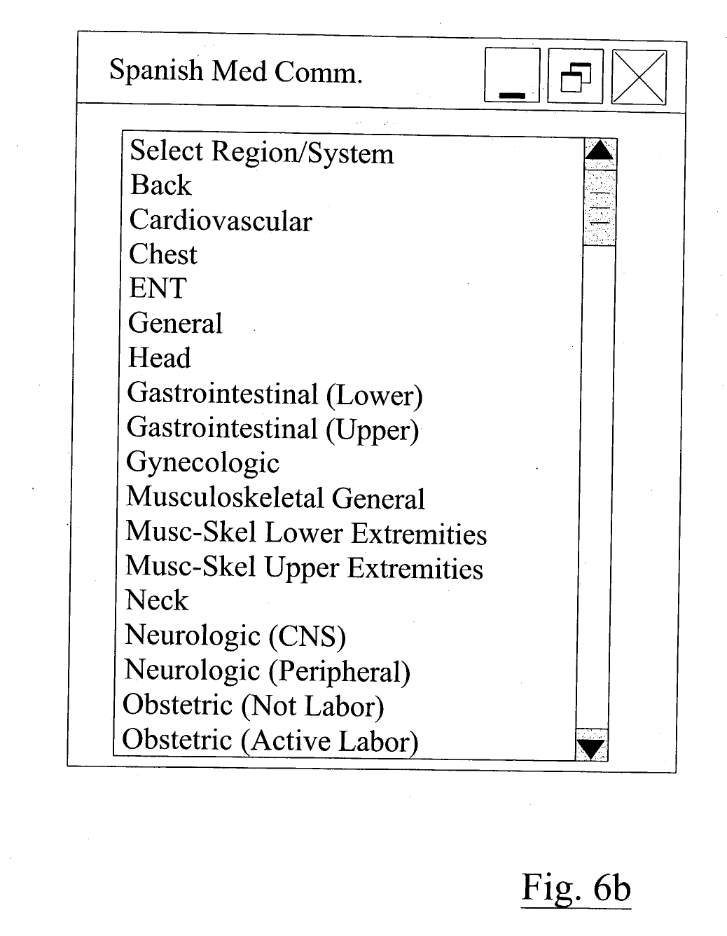

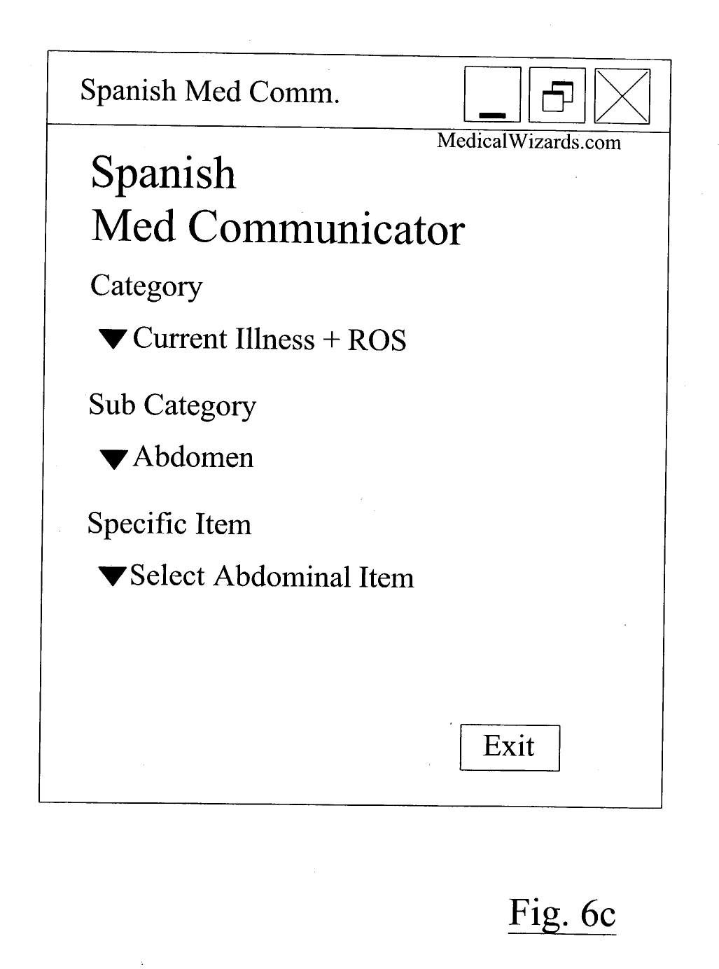

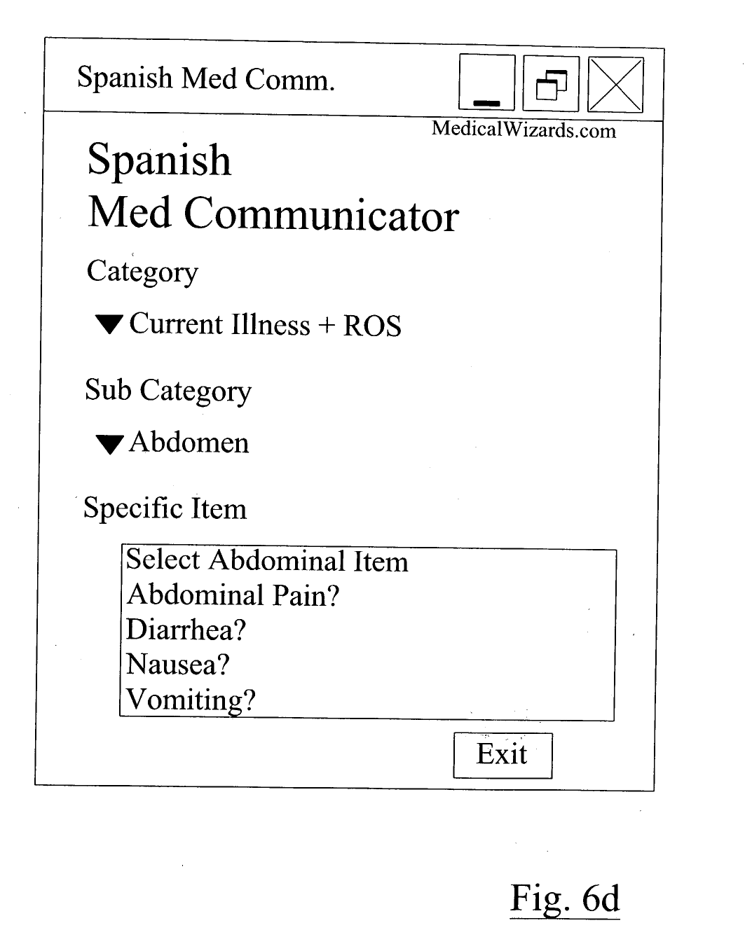

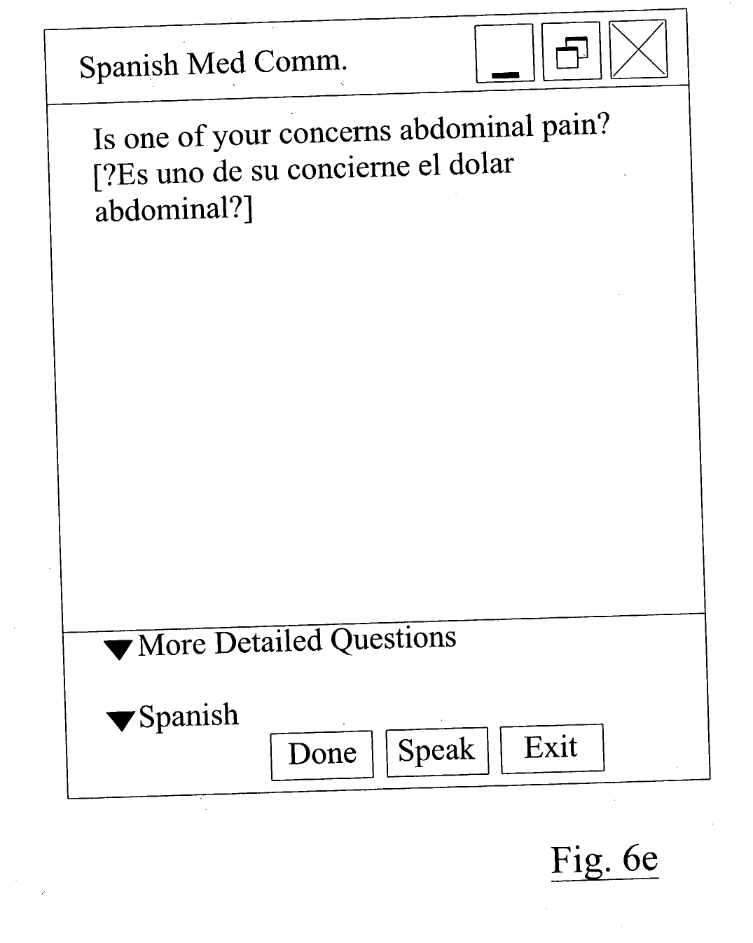

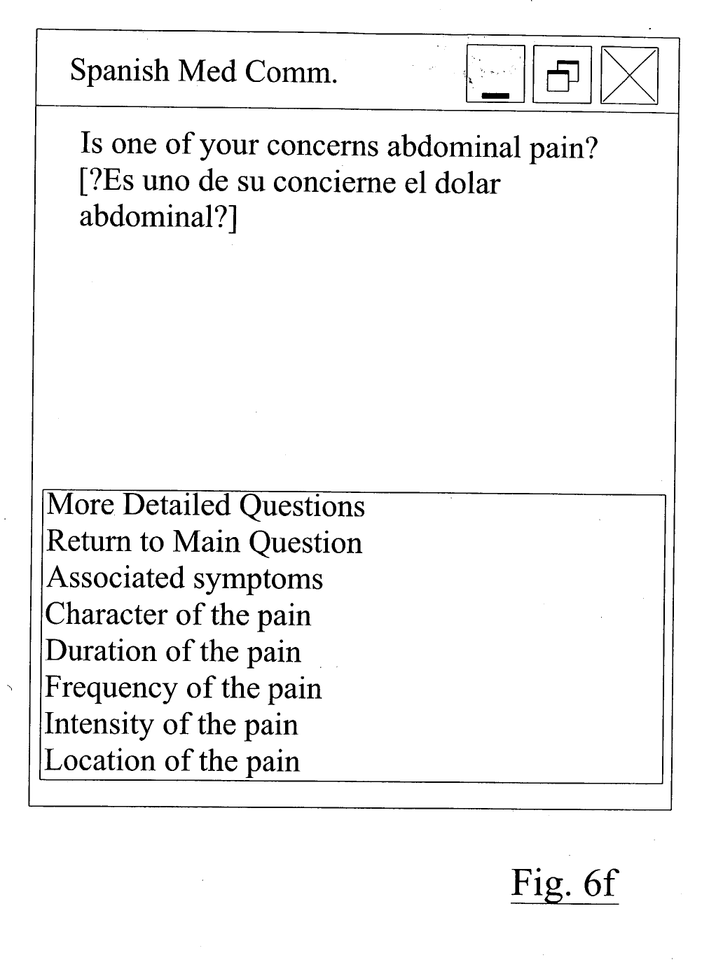

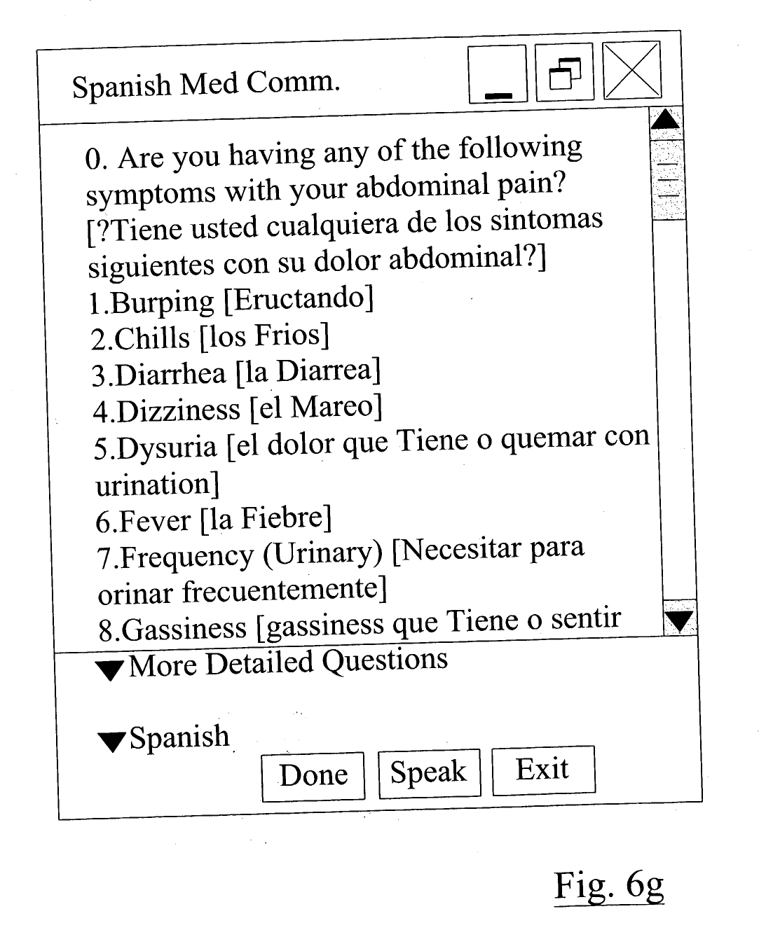

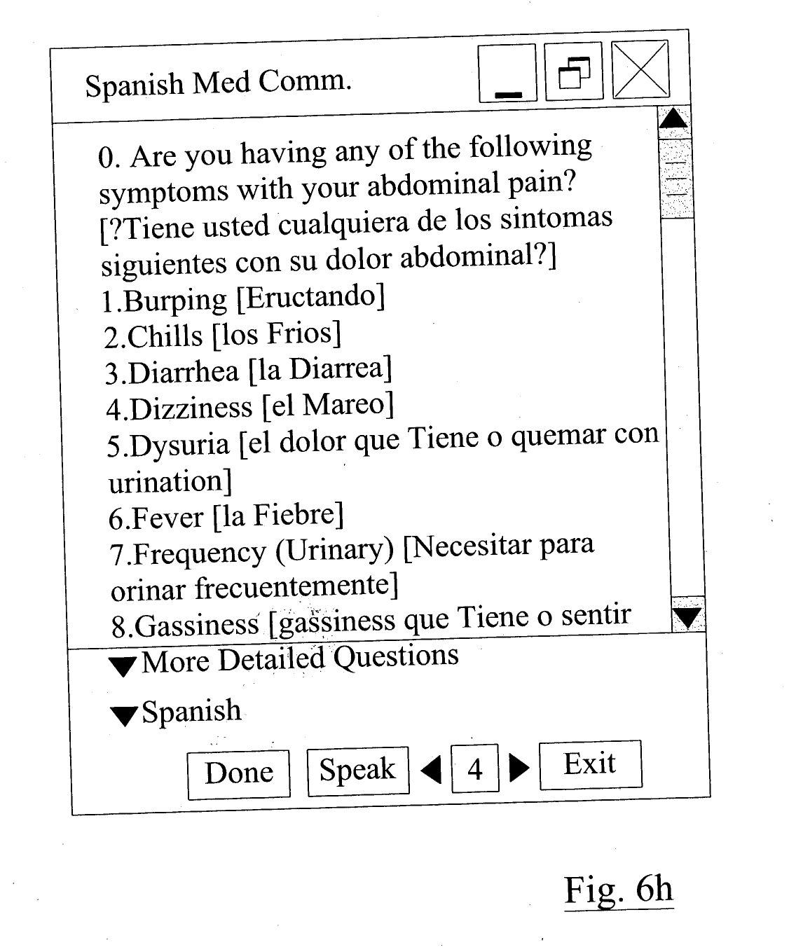

There may be numerous sub-menus based upon the main menu. FIGS. 6a through 6h illustrate exemplary menus and displays that are displayed based upon selections of the main menu and other sub-menus which are identified in the drawings description above. There are an unlimited number and type of menus that may be displayed and utilized with the present invention. The operator may select the desired options by physically selecting the item or by indicating a reference numeral associated with the specific item. For the medical industry, the sub-menus could include a main question with more detailed questions listed as shown in FIG. 6f of the drawings.

G. Operation and Functionality

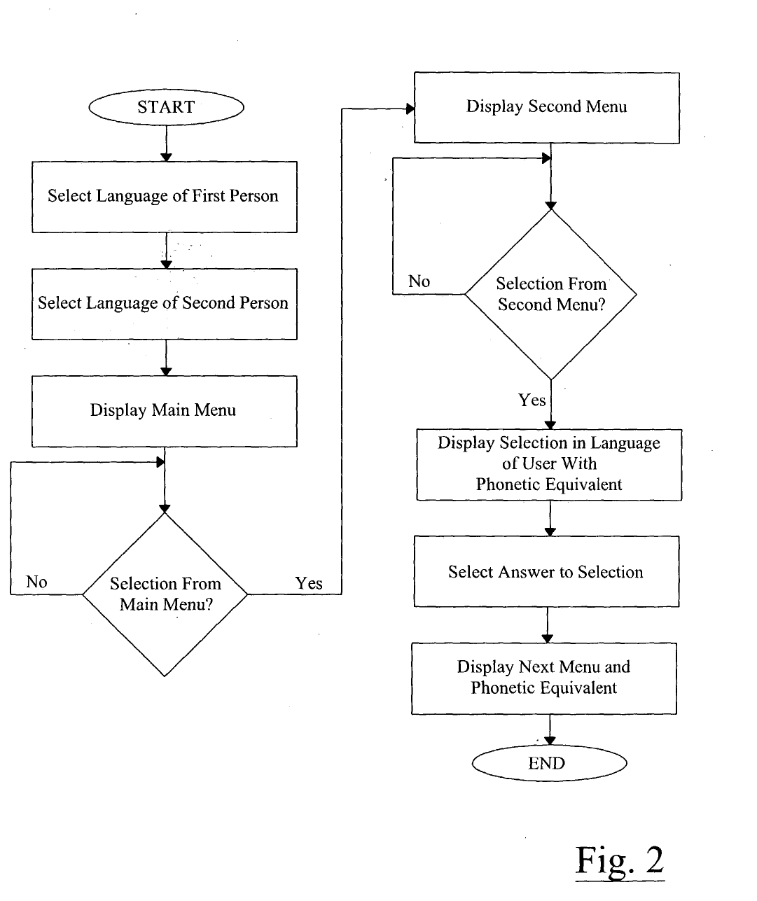

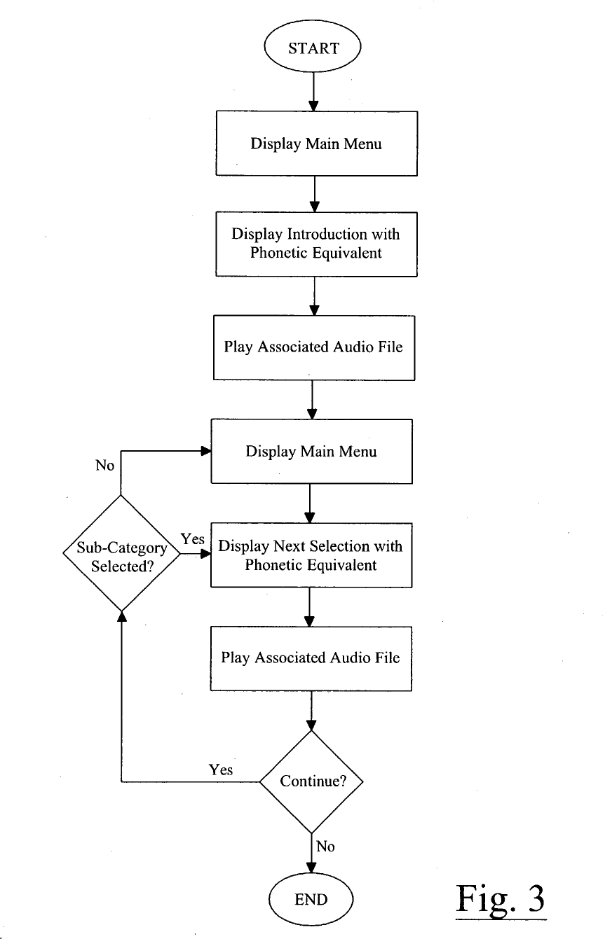

FIGS. 2 and 3 of the drawings illustrate the overall operation and functionality of the present invention. FIG. 2 illustrates that the first person selects their respective language and then selects the language of the second person which determines the language that the present invention displays the statements, questions and menus in. The present invention may be embodied having various databases which have the first language of the first person with numerous associated phonetic equivalents representing various languages.

The main menu is displayed to the first person in the first language as shown in FIG. 4 of the drawings (FIGS. 4 through 8 merely illustrate the usage of the present invention in the medical industry and should not limit the scope of usage of the present invention). The first person reviews the main menu and then selects the desired menu item. For example, if the first person desires to introduce themselves to the second person, they would select “Introduction to Patient” wherein the introduction would be displayed with the phonetic equivalent as shown in FIG. 5 of the drawings. The first person would review the statement and/or question of the introduction and then audibly read the phonetic equivalent to the second person. Alternatively, the first person would select the playing of the associated digital file which is in the language of the second person.

After the introduction, the first person may return to the main menu by selecting “Done” or similar button on the interface. The first person then may select another menu item from the main menu such as “Commands” which would display the Commands Menu as shown in FIG. 6 of the drawings. The first person would then select a sub-menu item that is appropriate which would display the appropriate command in the first language and the phonetic equivalent representing the second language.

FIG. 7 illustrates the usage of a main question with a series of sub-questions associated with the main question listed upon the same page. The first person would first read the main question and then audibly read the phonetic equivalent of the second language to the second person or alternatively play the audible voice file. The first person would be able to select and/or enter data into the interface based upon answers from the second person. The selections and input from the first person may determine the questions and/or statements illustrated upon the interface thereby guiding the first person through a series of questions and/or statements that will assist in making a medical diagnosis or other decision.

As to a further discussion of the manner of usage and operation of the present invention, the same should be apparent from the above description. Accordingly, no further discussion relating to the manner of usage and operation will be provided.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. Additionally, the above disclosure is not intended to limit the invention. The scope of the invention is defined by the appended claims.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A multi-language communication system, comprising:
a database containing a expression section in a first language and a phonetic equivalent section in a second language associated with said expression section; and
a display interface for querying, selecting and displaying a first expression from said expression section and a first phonetic equivalent from said phonetic equivalent section, wherein said first phonetic equivalent is the phonetic equivalent of said first expression in said second language.

2. The multi-language communication system of claim 1, wherein said first expression is comprised of a question.

3. The multi-language communication system of claim 1, wherein said first expression is comprised of a statement.

4. The multi-language communication system of claim 1, wherein said expression section has more than one language.

5. The multi-language communication system of claim 1, wherein said phonetic equivalent section has more than one language.

6. The multi-language communication system of claim 1, wherein said display interface displays said first expression followed by said first phonetic equivalent.

7. The multi-language communication system of claim 6, wherein said display interface displays a second expression followed by a second phonetic equivalent, wherein said second expression follows said first phonetic equivalent.

8. The multi-language communication system of claim 1, wherein a second expression and a second phonetic equivalent are displayed upon said display interface based upon a selection of said display interface relating to said first expression and said first phonetic equivalent.

9. The multi-language communication system of claim 1, wherein said first phonetic equivalent is expressed in an audible manner using a corresponding digital voice file.

10. The multi-language communication system of claim 9, wherein said display interface displays said first expression followed by said first phonetic equivalent.

11. An article of manufacture comprising a computer usable medium having computer readable program code embodied therein for facilitating verbal communication between a first person of a first language and a second person of a second language, said computer readable program code in the article of manufacture comprising:
computer readable program code for causing a computer to search a database for a first expression within said first language and a first phonetic equivalent within said second language, wherein said first phonetic equivalent is the phonetic equivalent of said first expression in said second language; and
computer readable program code for causing a computer to display said first expression and said first phonetic equivalent.

12. The article of manufacture comprising a computer usable medium of claim 11, wherein said first expression is comprised of a question.

13. The article of manufacture comprising a computer usable medium of claim 11, wherein said first expression is comprised of a statement.

14. The article of manufacture comprising a computer usable medium of claim 11, wherein said expression section has more than one language.

15. The article of manufacture comprising a computer usable medium of claim 11, wherein said phonetic equivalent section has more than one language.

16. The article of manufacture comprising a computer usable medium of claim 11, wherein said display interface displays said first expression followed by said first phonetic equivalent.

17. The article of manufacture comprising a computer usable medium of claim 16, wherein said display interface displays a second expression followed by a second phonetic equivalent, wherein said second expression follows said first phonetic equivalent.

18. The article of manufacture comprising a computer usable medium of claim 11, wherein a second expression and a second phonetic equivalent are displayed upon said display interface based upon a selection of said display interface relating to said first expression and said first phonetic equivalent.

19. The article of manufacture comprising a computer usable medium of claim 11, wherein said first expression and said first phonetic equivalent are expressed in a textual manner or an audible digital file.

20. A method of facilitating verbal communication between a first person of a first language and a second person of a second language, said method comprising the steps of:
(a) displaying a main menu readable by said first person;
(b) selecting an item of said main menu;
(c) displaying a first expression in said first language; and
(d) displaying a first phonetic equivalent of said first expression or playing an audible voice file which represents a translation of said first expression into said second language.
